(19) United States
(12) Patent Application Publication
(10) Pub. No.: US 2006/0204769 A1
(43) Pub. Date: Sep. 14, 2006

(54) Manufacturing method for obtaining high-performance components for gas turbines and components thus obtained

(76) Inventors: Alessandro Coppola, Prato (IT); Marco Innocenti, Pistoia (IT)

Correspondence Address: BLAKELY SOKOLOFF TAYLOR & ZAFMAN/PDC, 12400 WILSHIRE BOULEVARD, SEVENTH FLOOR, LOS ANGELES, CA, 90025, US

(21) Appl. No.: 10/539,216

(22) PCT Filed: Dec. 5, 2003
(86) PCT No.: PCT/EP03/14060

§ 371 Date: Apr. 17, 2006

(30) Foreign Application Priority Data
Dec. 18, 2002 (IT) MI2002A002676

(51) Int. Cl. B32B 15/04

(52) U.S. Cl. 428/469

(57) ABSTRACT

A manufacturing method for obtaining improved components (110) for gas turbines, which includes at least one process involving powder sintering or powder metallurgy with homogeneous/heterogeneous dispersion of powders; the invention also relates to the improved components obtained with this method.

The present invention relates to a manufacturing method for obtaining improved components for gas turbines.

The invention also relates to these improved components thus obtained.

As is known, gas turbines are machines consisting of a compressor and a single or multiple-stage turbine, where these components are connected together by a rotating shaft and where a combustion chamber is provided between the compressor and the turbine.

Air from the external environment is supplied to the compressor in order to pressurise it.

The pressurised air passes through a series of pre-mixing chambers which terminate in a converging portion and in each of which an injector feeds fuel which is mixed with the air so as to form an air/fuel mixture to be combusted.

The fuel is introduced into the combustion chamber and is ignited by means of suitable igniter plugs so as to produce combustion, which is aimed at causing an increase in temperature and pressure and therefore enthalpy of the gas.

At the same time, the compressor provides pressurised air which is made to pass both through the burners and through the linings of the combustion chamber so that the abovementioned pressurised air is available for fuelling combustion.

Subsequently, the high-temperature and high-pressure gas reaches, by means of suitable ducts, the different stages of the turbine, which converts the enthalpy of the gas into mechanical energy available for a user.

It is also known that, in order to obtain the maximum efficiency from a given gas turbine, the temperature of the gas must be as high as possible; however, the maximum temperature values which can be reached during use of the turbine are limited by the strength of the materials used.

In fact, the increase in the compression ratio and the combustion temperature have a synergic effect on the performance characteristics of the gas turbine cycle, be it of the single or combined type: manufacturers are aware that their competitiveness within the market depends on the ability to make progress in this connection.

These two parameters must be clearly defined in relation to the technology and materials which, for the sake of economic advantage, are to be used during design of the machine.

According to the present state of the art, it is envisaged, for example, that the stator blades of the first expansion stages of a gas turbine are made by means of microfusion of typically nickel or cobalt-based superalloys, always in conjunction with cooling measures.

The following stages are also made by means of microfusion of superalloys, all cobalt or nickel-based materials with an excellent oxidation resistance and reasonable mechanical properties, at least up to temperatures of about 800° C.; in the case of higher temperatures suitable cooling is therefore required.

In view of the temperatures involved, the oxidation resistance and corrosion strength of these superalloys in the hot state would clearly be inadequate if cooling and screening of the surfaces with a film of cooling air were not envisaged.

The cooling techniques, no matter how sophisticated, would nevertheless no longer be able to ensure an adequate duration of the components if technologies for protecting the metal surfaces with the application of heat and anti-oxidant barriers had not been introduced.

At present, the increase in the current performance characteristics is now sought after, rather than by using increasingly sophisticated basic materials for the blades, by means of the development of heat and anti-corrosion barriers and generally coatings which offer an increasingly optimum performance compared to the present platinum, chromium and aluminium linings.

However, the development of heat barriers is also reaching its limits in terms of manufacturing and application technologies.

Basically it is noted that, during the use in industrial gas turbines with high combustion temperatures, the components of the gas turbine made of homogeneous metallic and non-metallic materials have a low resistance to the high-temperature thermomechanical stresses.

It is therefore necessary to adopt compromises during the design and choice of materials in order to achieve performance characteristics which are acceptable in terms of duration, reliability, industrial feasibility and performance of the machine in which these components are incorporated.

The consequence of this is also the difficulty of developing cooling flows which are suitable for limiting the oxidation of the metal components used.

In practice, the increasingly greater efficiency levels required result in an increase in the cycle temperatures which render the conventional constructional solutions unsuitable from the point of view of increasing and/or maintaining the working life of the components which are subject to high temperatures, or so-called hot components.

The object of the present invention is therefore that of overcoming the drawbacks mentioned above and in particular that of indicating a manufacturing method for obtaining high-performance components for gas turbines which manage to withstand increasingly higher temperatures.

Another object of the present invention is that of providing improved components for gas turbines which allow the attainment of very high compression ratios which cannot be achieved conveniently with the components known in the art.

Another object of the present invention is that of indicating a manufacturing method for obtaining improved components for gas turbines which are particularly reliable, with a relatively limited cost.

These and other objects according to the present invention are achieved by indicating a manufacturing method for obtaining improved components for gas turbines, as described in claim 1. Claim 6 specifies how these improved components for gas turbines are obtained. Further characteristic features of the invention are envisaged in the remaining claims.

The characteristic features and advantages of a manufacturing method for obtaining improved components for gas turbines and the components thus obtained in accordance with the present invention will become clearer and more obvious from the following description provided by way of a non-limiting example, with reference to the accompanying schematic drawings in which:

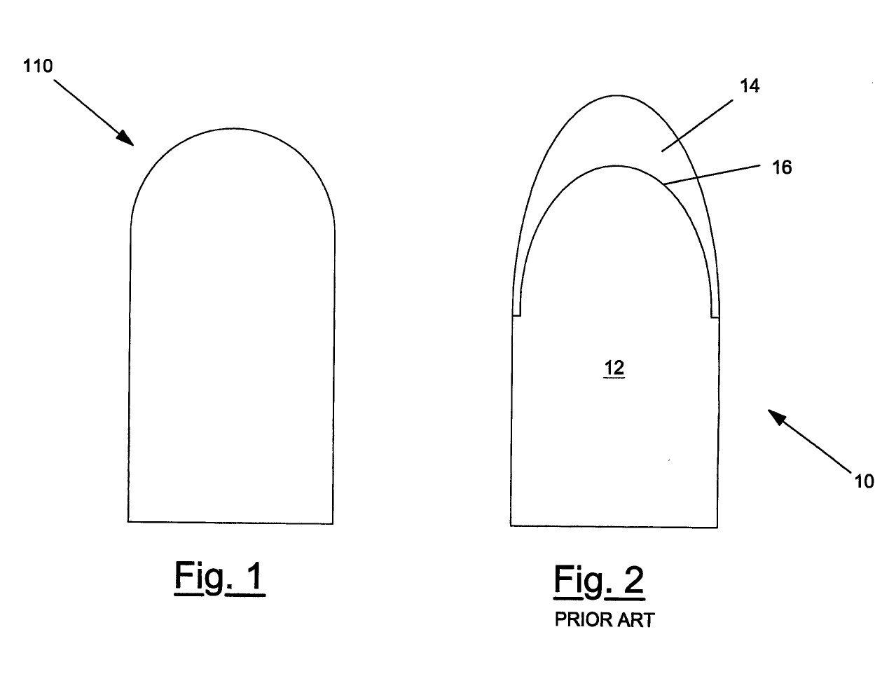

FIG. 1 is a diagram of an improved component part for gas turbines, obtained in accordance with the manufacturing method of the present invention;

FIG. 2 is a diagram of the same component part as in FIG. 1, obtained in accordance with the prior art.

With initial reference to FIG. 2, this shows a part of a component for gas turbines, which is denoted overall by 10 and obtained in accordance with the prior art.

The component 10 comprises an internal metal body 12 obtained by means of microfusion or mechanical machining. An external protective body 14 made of generally homogeneous ceramic material is added on top of it. An interface and bonding zone 16 is provided between the internal body 12 and the external body 14.

In the example illustrated in FIG. 1, according to the present invention, part of an improved component 110 for gas turbines, obtained in accordance with the manufacturing method of the present invention, is shown.

The improved component 110 is made by means of at least one process involving metallic and non-metallic powder sintering or powder metallurgy with homogeneous/heterogeneous dispersion of the powders.

The dispersion or diffusion of the said powders is performed in a predefined manner so as to expose surfaces with suitable concentrations of high-refractory non-metallic powders to very high temperature gaseous flows.

Moreover, the diffusion of the powders performed in this predefined manner allows perfect fixing to the metal surfaces in a zone forming an interface with internal bodies produced by means of microfusion.

The composition of the sintered product, owing to suitable balancing and diffusion of the powders during production and distribution of the concentrated component powders within the geometry of the sintered product, results in different chemical/physical properties in different points with a relative variability determined by the functional specification defined during the design stage.

As a result of this manufacturing technique it is therefore possible to obtain an optimum tensile and thermal stress distribution, with an optimum strength of the sintered component, thereby maximising the working life of the component.

It is clear from that stated that the present invention represents a technological leap from components made of isotropic and homogeneous materials, if necessary with coatings of various kinds, to sintered powder components which have different properties in different points with continuous variation thereof. This is due to a composition which is no longer uniform, but continuously variable and suitably calibrated according to the requirements of the various zones of the component.

Suitable distribution of the powders, for example, result in components having a maximum refractoriness in respect of hot gases, along with an improved behaviour at the bonding interface with a microfusion zone of the component: in this way the sintered product is not simply a coating of the component, but forms an integral part thereof.

The main result of the present invention is the possibility of achieving a robust design with the manufacture of inserts made of material resistant to high temperatures, obtained by means of sintering of mixtures of metallic and non-metallic powders with heterogeneous/homogeneous dispersion.

The above description clearly demonstrates the characteristic features of the manufacturing method for obtaining improved high-performance components for gas turbines and the components thus obtained, according to the present invention, as well as the advantages arising therefrom.

The following final considerations and comments are added here in order to define more precisely and clearly the abovementioned advantages.

Firstly it is pointed that, with the manufacturing method for obtaining improved high-performance components for gas turbines according to the invention, it is possible to obtain components which are resistant to very high temperatures.

In this way very high compression ratios of the gas turbine are achieved, of the kind which cannot be obtained economically with the components known in the art, while ensuring the availability of very reliable parts at a relatively low cost.

Finally it is clear that the manufacturing method for obtaining improved high-performance components for gas turbines as well as the resultant components, thus conceived, may be subject to modifications and variations all within the scope of the invention; moreover all the details may be replaced by technically equivalent elements. In practice the materials used, as well as the forms and dimensions, may be of any nature in accordance with the technical requirements.

The scope of protection of the invention is therefore delimited by the accompanying claims.

1. Manufacturing method for obtaining improved high-performance components (110) for gas turbines, characterized in that it includes at least one process involving powder sintering or powder metallurgy with homogeneous/heterogeneous dispersion of said powders.

2. Manufacturing method according to claim 1, characterized in that said powders are metallic and non-metallic.

3. Manufacturing method according to claim 1, characterized in that said dispersion of said powders is performed in a predefined manner resulting in suitable concentrations of said powders in suitably designated zones.

4. Manufacturing method according to claim 1, characterized in that said dispersion of said powders is performed in a predefined manner resulting in perfect fixing to metal surfaces in a zone (16) forming an interface and bond with internal bodies (12) produced by means of microfusion or mechanical machining.

5. Manufacturing method according to claim 1, characterized in that said dispersion of said powders is performed with suitable balancing and dispersion of said powders which produces different chemical/physical properties in different points of said components.

6. Improved high-performance components (110) for gas turbines, characterized in that they are obtained by means of at least one process involving powder sintering or powder metallurgy with homogeneous/heterogeneous dispersion of said powders.

7. Improved high-performance components (110) according to claim 6, characterized in that distribution of said powders results in maximum refractoriness and resistance in respect of hot gases.

8. Improved high-performance components (110) according to claim 6, characterized in that distribution of said powders results in perfect fixing to metal surfaces in a zone (16) forming an interface and bond with internal bodies (12) produced by means of microfusion or mechanical machining.
